(19) United States
(12) Patent Application Publication
(10) Pub. No.: US 2026/0030344 A1
(43) Pub. Date: Jan. 29, 2026

(54) MEMORY SYSTEM AND CONTROLLER

(71) Applicant: Kioxia Corporation, Tokyo (JP)

(72) Inventor: Hisaya MIYAMOTO, Yokohama (JP)

(73) Assignee: Kioxia Corporation, Tokyo (JP)

(21) Appl. No.: 19/059,403

(22) Filed: Feb. 21, 2025

(30) Foreign Application Priority Data
Jul. 23, 2024 (JP) 2024-117943

(51) Int. Cl. G06F 21/54; G06F 21/55; G06F 21/79

(52) U.S. Cl. CPC G06F 21/54; G06F 21/552; G06F 21/79

(57) ABSTRACT

According to one embodiment, a memory system includes a nonvolatile memory and a controller. The controller includes a security block which provides a security function related to the nonvolatile memory. The security block includes a first CPU and a second CPU. The first CPU performs communication with an external module which requests the security function, accepts an interruption generated in the security block, and performs task management in the security block such that a security process corresponding to the request is performed without suspension considering the security process as one task. The second CPU performs the security process under control of the first CPU.

### CROSS-REFERENCE TO RELATED APPLICATIONS

This application is based upon and claims the benefit of priority from Japanese Patent Application No. 2024-117943, filed Jul. 23, 2024, the entire contents of which are incorporated herein by reference.

### FIELD

Embodiments described herein relate generally to a memory system and a controller.

### BACKGROUND

Mounting of a security function on built-in devices is no longer uncommon. For example, integrated circuit (IC) cards aim to realize security itself. In devices which reproduce moving images, such as Blu-ray Disc players, set-top boxes (STBs) and streaming devices connected to a network, the security function is an important constituent element for establishing their functions and services.

In general, a process which is responsible for security is required to start its operation when needed, complete the process without being suspended, and in the stage of terminating the process, erase the traces of critical security parameters etc., used in the process. This is because there are attacks which intentionally suspend a process which is responsible for or related to security, obtain information related to security from a system memory or a cache memory which is the resource of a central processing unit (CPU) and use the information. However, as built-in devices need to mount an interrupt process to realize their functions, the security process has to be suspended depending on the mounting.

In built-in systems, the role of an operating system (OS) is also important. When the security function operates on an OS as a task, for the security function, in addition to suspension by CPU exception or external interruption, the execution is controlled by the scheduler of the OS, and dispatch is performed based on the priority of the task which performs security function. The task which is responsible for the security function cannot restart the process unless conditions such as the priority in a ready queue managed by the OS and the position in the queue are fulfilled. This situation is not preferable for the security process.

One mode of a built-in device is mounting for causing a dedicated CPU to perform the security function. The pioneering examples of this mounting are B-cas cards in television (TV) and trusted platform modules (TPMs) in personal computers (PCs). However, in this mechanism which is independently responsible for the security function, similarly, the use of CPU exception or interruption or the dispatch by an OS is not unrelated.

### BRIEF DESCRIPTION OF THE DRAWINGS

FIG. 1 is a diagram showing an example of a configuration of a memory system according to a first embodiment.

FIG. 2 is a diagram showing an example of a configuration of an SECB in the memory system according to the first embodiment.

FIG. 3 is a diagram for explaining the operation of a kernel CPU which allows a task CPU to perform a security process without suspension in a security block (SECB) of the memory system according to the first embodiment.

FIG. 4 is a diagram for explaining the optimization of power consumption realized by a memory system by alternately using power between a task CPU and each IP according to a second embodiment.

FIG. 5 is a diagram for explaining the individual power control of the task CPU/each IP by a plurality of mutexes realized by the memory system according to the second embodiment.

FIG. 6 is a diagram for explaining effective updating of the operation parameter of an operation device having a plurality of channels realized by a memory system according to a third embodiment.

### DETAILED DESCRIPTION

In general, according to one embodiment, a memory system includes a nonvolatile memory and a controller. The controller includes a security block which provides a security function related to the nonvolatile memory. The security block includes a first CPU and a second CPU. The first CPU performs communication with an external module which requests the security function, accepts an interruption generated in the security block, and performs task management in the security block such that a security process corresponding to the request is performed without suspension considering the security process as one task. The second CPU performs the security process under control of the first CPU.

Embodiments will be described hereinafter with reference to the accompanying drawings.

### First Embodiment

First, a first embodiment is explained.

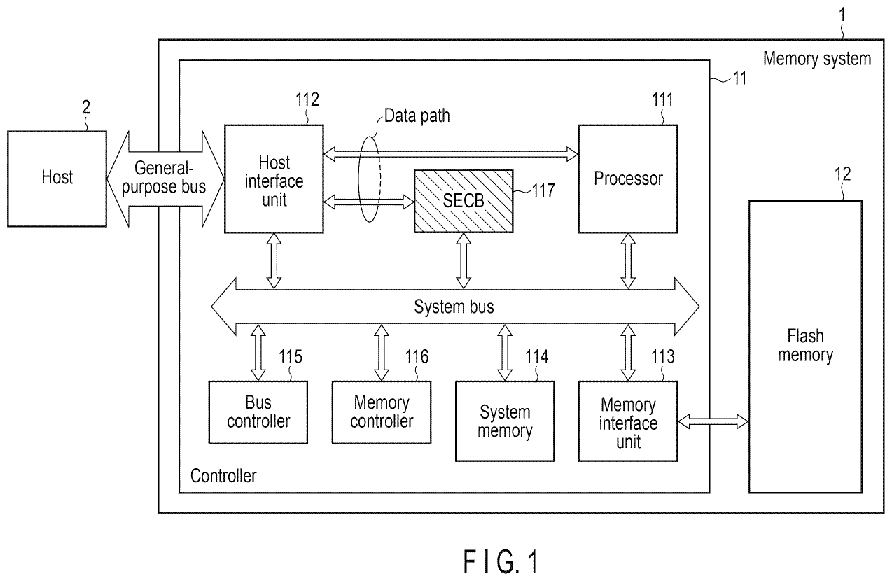

FIG. 1 is a diagram showing an example of a configuration of a memory system 1 according to the first embodiment. FIG. 1 also shows an example of a configuration of an information processing system including the memory system 1 of the first embodiment and a host 2 connected to the memory system 1. The host 2 is, for example, an information processing device such as a PC or a server.

Here, this specification shows an example in which the memory system 1 is realized as a solid state drive (SSD). The memory system 1 is not limited to an SSD, and may be realized as various types of data storage devices such as a hard disk drive (HDD).

The memory system 1 comprises a controller 11 and a flash memory 12. Here, the flash memory 12 is a NAND flash memory.

The controller 11 writes data to the flash memory 12 and reads data from the flash memory 12 in accordance with a command from the host 2. The controller 11 is realized as, for example, a system-on-a-chip (SoC).

The controller 11 comprises a processor 111, a host interface unit 112, a memory interface unit 113, a system memory 114, a bus controller 115, a memory controller 116 and a security block (SECB) 117. The units 111 to 117 of the controller 11 are mutually connected via a system bus.

The processor 111 is a device which controls the operation of the memory system 1 in an integrated manner. Specifically, the processor 111 appropriately controls the operation of the host interface unit 112, the memory interface unit 113, the system memory 114, the bus controller 115, the memory controller 116 and the SECB 117.

The host interface unit 112 is a circuit which controls communication with the host 2 via a general-purpose bus compliant with interface standards such as PCI Express™ (PCIe™). The host interface unit 112 stores write data received from the host 2 in the system memory 114 or transmits read data read from the flash memory 12 and stored in the system memory 114 to the host 2. The host interface unit 112 can supply interrupt signals to the processor 111 and the SECB 117 by using a data path in which the purpose is defined in advance. For example, the host interface unit 112 can notify the processor 111 and the SECB 117 that a command is received from the host 2 by an interrupt signal. The host interface unit 112 has the function of analyzing a command from the host 2 regarding whether the command is a command which should be notified to the processor 111 or a command which should be notified to the SECB 117.

The memory interface unit 113 is a circuit which controls data write to the flash memory 12 and data read from the flash memory 12. Specifically, the memory interface unit 113 writes write data stored in the system memory 114 to the flash memory 12 or reads data from the flash memory 12 and stores the data in the system memory 114 as read data.

The system memory 114 is a storage medium used as the work area of each unit provided in the controller 11. The system memory 114 is, for example, a static random access memory (static RAM [SRAM]).

The bus controller 115 is a device which performs arbitration related to the acquisition of the right to use the system bus. When a collision occurs to obtain the right to use the system bus between two or more devices connected to the system bus, for example, the bus controller 115 provides these devices with the right to use the system bus in time-divisional manner.

The memory controller 116 is a circuit which controls, for example, the allocation of the area of the system memory 114 for temporarily storing write data and read data, and the release of an allocated area of the system memory 114 in which write data whose write to the flash memory 12 has been completed or read data whose transfer to the host 2 has been completed is stored, based on an instruction from the processor 111.

The SECB 117 is a device which provides a security function related to the flash memory 12. The SECB 117 comprises a dedicated CPU which is responsible for a security process. The details of the dedicated CPU which is provided in the SECB 117 and is responsible for a security process are described later.

The SECB 117 performs, for example, a security process such as the authentication of a user who is allowed to write data to the flash memory 12 and read data from the flash memory 12. The controller 11 prohibits the data access to the flash memory 12 by a user who failed in authentication in the SECB 117.

The SECB 117 may have the function of allocating the area of the flash memory 12 to each user who has a permission for the data access to the flash memory 12. In this case, it is possible to prevent data which is written to the flash memory 12 by a user from being read from the flash memory 12 by another user. The SECB 117 may have the function of generating and managing an encryption key for each user who has a permission for the data access to the flash memory 12. In this case, further, even if the memory system 1 is taken away, it is possible to substantially prevent the data in the flash memory 12 from being stolen by a third person by encrypting write data and writing the data to the flash memory 12 or decrypting encrypted read data read from the flash memory 12 using encryption keys which are generated and managed by the SECB 117 and are different from each other depending on the user.

The security process performed by the SECB 117 is not limited to the authentication of each user and may include various types of processes. For example, the SECB 117 may perform the allocation of the area of the flash memory 12 or the generation and management of encryption keys for respective users as a security process. Further, the SECB 117 may perform the encryption and decryption of data using encryption keys generated and managed by itself as a security process.

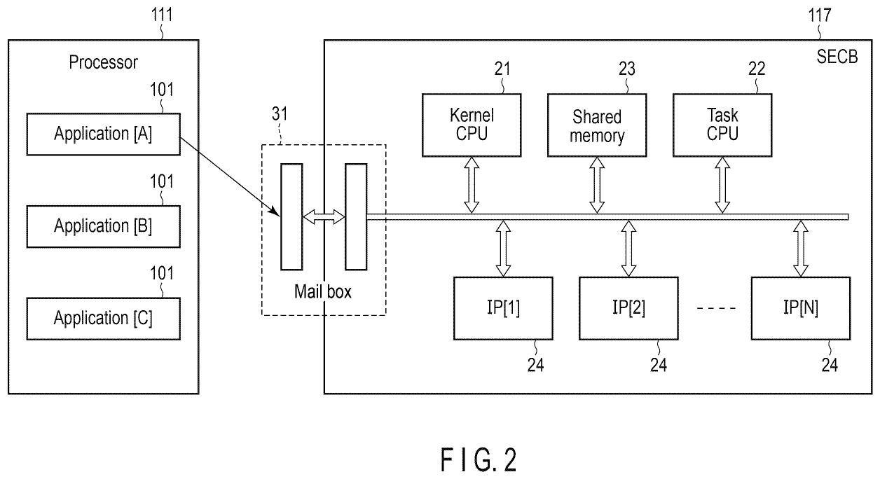

FIG. 2 is a diagram showing an example of a configuration of the SECB 117 in the memory system 1 according to the first embodiment. In FIG. 2, application [A] 101, application [B] 101 and application [C] 101 are programs executed by the processor 111 of the controller 11 and are programs which could request the SECB 117 to perform a security process. In other words, they are external modules which request a security function.

For example, this specification assumes a case where application [B] 101 requests the SECB 117 to perform a security process while the dedicated CPU which is responsible for a security process in the SECB 117 performs a security process in response to a request from application [A] 101. In this case, an interrupt process for accepting the request from application [B] 101 occurs in the SECB 117. In general, to deal with this interrupt process, the dedicated CPU which is responsible for a security process in the SECB 117 has to suspend the security process which is in progress for responding to the request from application [A] 101. The suspension of the security process is not preferable in terms of the conservation of information related to security.

To the contrary, for example, if no interruption is accepted during the execution of a security process, the interrupt latency time from the occurrence of an interruption until the accepting of the interruption (not until the start of an interrupt process) is increased.

In consideration of this problem, the SECB 117 in the memory system 1 of the first embodiment comprises a mechanism for realizing both the reduction in the interrupt latency time and the non-suspension of a security process. This mechanism is explained in detail below.

As shown in FIG. 2, the SECB 117 comprises a kernel CPU 21, a task CPU 22, a shared memory 23 and a plurality of processing circuits (intellectual properties [IPs]) [1, 2, . . . , N] 24.

In a built-in system comprising a dedicated CPU which is responsible for a security process, a means of communication is needed between a CPU which is responsible for applications and the CPU which is responsible for a security process. Here, this communication mechanism is called a mail box. It should be noted that this mechanism does not assume a specific OS specification or specific hardware. Here, the mechanism is positioned as a means of communication between general-purpose CPUs.

A CPU which is responsible for a security process receives a request via the mail box and performs a process in response to the request. It is assumed that the source of the request is a plurality of tasks which operate on a CPU which is responsible for a plurality of applications or a CPU which is responsible for a single application. In this case, the means for communication between CPUs should be protected by a mechanism of exclusive control (for example, semaphore or mutex). However, when a plurality of tasks which operate on a single CPU use this mail box, a short period for operating the mail box should be merely set so as to be an interrupt prohibition zone (or a task dispatch prohibition zone).

To the contrary, a dedicated CPU which is responsible for a security process needs to receive requests from a plurality of tasks via the mail box and appropriately manage the requests regardless of the processing situation. At this time, to prevent the suspension of a security process as much as possible, in the memory system 1 of the first embodiment, the SECB 117 comprises two dedicated CPUs which are responsible for a security process (the kernel CPU 21 and the task CPU 22).

Here, one of the CPUs (kernel CPU 21) is positioned as a kernel CPU and is caused to have the function of an operating system such as the accepting of interruptions from a mail box 31 and the IPs 24, the reception of requests from the outside, the transmission of responses to the outside, the management of the priorities of the received requests, and task management. The other CPU (task CPU22) is positioned as a task CPU which performs a security process based on an instruction from the kernel CPU 21. The task CPU 22 receives control from the kernel CPU 21 via the shared memory 23. The task CPU 22 requests one or more IPs 24 to perform a process depending on the need.

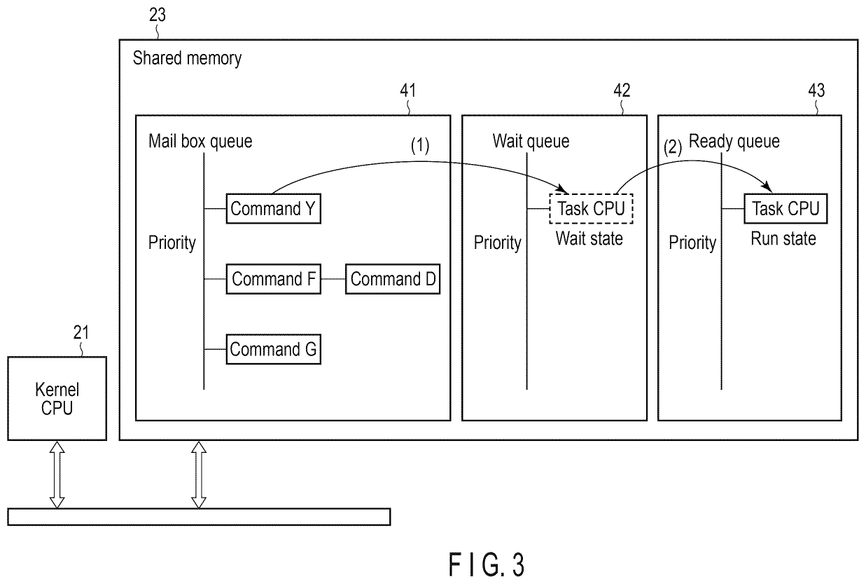

This specification explains the operation of the kernel CPU 21 for allowing the task CPU 22 to perform a security process without suspension with reference to FIG. 3.

The kernel CPU 21 manages received requests in a queue (mail box queue 41) based on priorities on the basis of the processing priority given to each received request. For example, the kernel CPU 21 prepares the mail box queue 41 in the shared memory 23.

FIG. 3 shows an example in which four commands, specifically, command Y having the highest priority, commands F and D having the second priority and command G having the lowest priority, are managed by the kernel CPU 21 in the mail box queue 41. Commands F and D having the same priority are arranged in the order in which they were accepted by the SECB 117. The execution order of the four commands shown in FIG. 3 are the order of command Y, command F, command D and command G.

Further, FIG. 3 shows an example in which the state of the task CPU 22 is managed by the kernel CPU 21 in a wait queue 42 and a ready queue 43. In a manner similar to that of the mail box queue 41, for example, the kernel CPU 21 prepares the wait queue 42 and the ready queue 43 in the shared memory 23.

When the task CPU 22 is in a wait state, the kernel CPU 21 stores information indicating the task CPU 22 in the wait queue 42. When information indicating the task CPU 22 is stored in the wait queue 42, the kernel CPU 21 stores, in the shared memory 23, information necessary to execute command Y which should be executed at the head of the commands stored in the mail box queue 41, and instructs the task CPU 22 to execute command Y using the information stored in the shared memory 23 (FIG. 3 (1)). At this time, the kernel CPU 21 erases command Y from the mail box queue 41.

When the kernel CPU 21 determines that the task CPU 22 can perform the process of command Y, the kernel CPU 21 removes the information indicating the task CPU 22 from the wait queue 42, changes the connection to the ready queue 43 and changes the state of the task CPU 22 to a run state (FIG. 3 (2)). When the task CPU 22 can perform the process of command Y, the information indicating the task CPU 22 is connected to the wait queue 42. In a case where the task CPU 22 terminates the process of command Y, the kernel CPU 21 extracts the information indicating the task CPU 22 from the ready queue 43 and moves it to the wait queue 42. In a case where the information indicating the task CPU 22 is present in the wait queue 42, if a command which waits for execution is present in the mail box queue 41, the kernel CPU 21 causes the task CPU 22 to execute the command. In other words, the kernel CPU 21 stores information necessary to execute command F which should be executed next in the shared memory 23 and instructs the task CPU 22 to execute command F using the information stored in the shared memory 23.

In this manner, the kernel CPU 21 monitors the state of the task CPU 22. At this time, the kernel CPU 21 refers to and operates the control information of the task CPU 22. The same data structure as a task control block (TCB), which is used when an OS controls a task in general, may be applied.

When the state of the task CPU 22 registered in the TCB is a state for waiting for the reception of a request (from the kernel CPU 21), the kernel CPU 21 provides the task CPU 22 with the information of the processing target via the shared memory 23 and switches the state of the task CPU 22 to a run state. At this time, the kernel CPU 21 searches the mail box queue 41 for a request having a high priority from the managed requests, determines the request located at the head of the mail box queue 41 and having the highest priority as the processing target, removes the request from the mail box queue 41 and delivers it to the task CPU 22. By managing the requests in this manner, the security process is not suspended by interruptions, and in addition, tasks can be scheduled in accordance with the priorities of processes. Further, for example, since interruptions generated by the mail box 31 and the IPs 24 are accepted by the kernel CPU 21, the interruption latency time can be reduced.

As described above, in the memory system 1 of the first embodiment, the SECB 117 comprises two dedicated CPUs which are responsible for a security process (the kernel CPU 21 and the task CPU 22), thereby realizing both the reduction in the interruption latency time and the non-suspension of a security process.

It should be noted that the number of dedicated CPUs which are responsible for a security process is not limited to two, and may be three or more. Specifically, two or more task CPUs 22 may perform different security processes under the control of one kernel CPU 21.

### Second Embodiment

Now, this specification explains a second embodiment. In a manner similar to that of the first embodiment, the second embodiment is assumed to be a memory system 1 realized as, for example, an SSD. The same structural elements as the first embodiment are denoted by the same reference numbers. Thus, explanation thereof is omitted.

The memory system 1 of the second embodiment is an example of an application using the configuration explained in the first embodiment in which two CPUs, specifically, a kernel CPU 21 and a task CPU 22, are provided, and the task CPU 22 operates under the control of the kernel CPU 21.

In built-in devices, power consumption is also an important matter which cannot be ignored. In case of a contactless IC card using the limited power obtained from an antenna, the request on power consumption is noticeable. Even in an automobile which mounts a power generator, the request on power consumption with respect to the mounted devices is relatively strict.

In the memory system 1 of the second embodiment, power consumption is optimized by considering power as a resource and introducing appropriate execution control between a CPU (task CPU 22) and each IP (IP 24).

In the first embodiment, a TCB is introduced to control the task CPU 22. In the second embodiment, assuming that each IP 24 is also a task, the same TCB is used to control the IPs 24, and the state of hardware is controlled.

Thus, in the second embodiment, the task CPU 22 and each IP 24 are dealt with as presence equivalent to a task which mounts software by the kernel CPU 21, and have the same state as a normal task (an idle state, a wait state, a run state, etc.). The state of the task CPU 22 and the IPs 24 is managed and controlled by the kernel CPU 21. The operation of the task CPU 22 and the IPs 24 is managed by the scheduling function of the kernel CPU 21.

### (1) Optimization of Power Consumption by Alternately Using Power Between the Task CPU 22 and Each IP 24

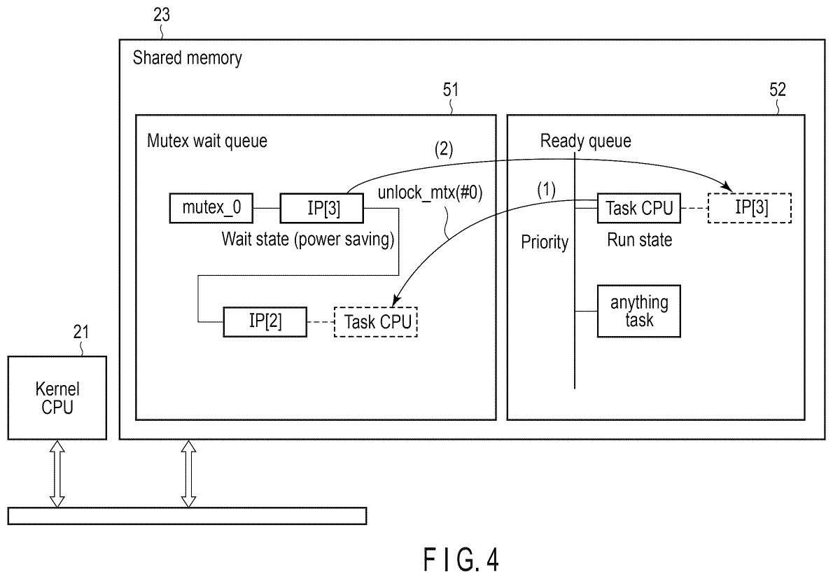

FIG. 4 is a diagram for explaining the optimization of power consumption realized by the memory system 1 by alternately using power between the task CPU 22 and each IP 24 according to the second embodiment.

For example, the kernel CPU 21 prepares a mutex wait queue 51 and a ready queue 52 in a shared memory 23.

The task CPU 22 and each IP 24 attempts to lock mutex_0 when power is used. Under mutex_0, each of the task CPU 22 and the IPs 24 may be either in a mutex lock wait state (power cannot be used) or a mutex lock state (power can be used). The kernel CPU 21 monitors this state.

In a manner similar to that of a normal mutex, the operation of the CPU 22 or each IP 24 in a mutex lock state is not disturbed by the task CPU 22 or each IP 24 in a mutex lock wait state. The kernel CPU 21 appropriately controls the priority of the task CPU 22 or each IP 24 in a mutex lock state.

The number of mutexes which can be locked by one task is limited to one. However, in power control, a system task which locks a plurality of mutexes could be exceptionally present. When the task CPU 22 or an IP 24 in a mutex lock state unlocks a mutex, the task CPU 22 or an IP 24 in a mutex lock wait state transitions to a mutex lock state. The task CPU 22 which unlocked a mutex transitions to a mutex lock wait state after being removed from the ready queue 52. Thus, the task CPU 22 is always in a state which can return to the ready queue 52.

To the contrary, an IP 24 which unlocked a mutex transitions to a dormant state in which the IP 24 is removed from the ready queue 52. The IP 24 in a dormant state transitions to a mutex lock wait state by a system call from the task CPU 22.

FIG. 4 shows a state in which the task CPU 22 in a run state unlocks mutex_0 and transitions to a power-saving state (FIG. 4 (1)), and IP [3] 24 in the lock wait state of mutex_0 obtains the right of execution (FIG. 4 (2)).

### (2) Individual Power Control of the Task CPU 22/Each IP 24 by a Plurality of Mutexes

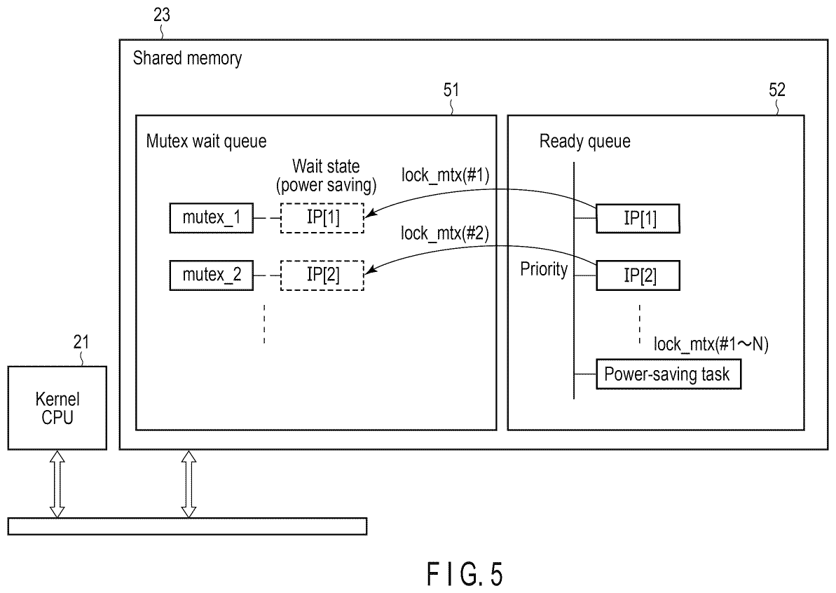

FIG. 5 is a diagram for explaining the individual power control of the task CPU 22/each IP 24 by a plurality of mutexes realized by the memory system according to the second embodiment.

When the system is activated or the entire system transitions to a power-saving state, the task CPU 22 or each IP 24 may individually operate in some cases. In these cases, individual mutexes (mutex_n) are allocated to the task CPU 22 and the IPs 24.

In this case, similarly, the task CPU 22 and the IPs 24 are under the control of the kernel CPU 21. As individual mutexes are allocated to the task CPU 22 and the IPs 24, in principle, the task CPU 22 and each IP 24 can operate at the same time. For example, mutex_1 is allocated to the task CPU 22, and mutex_2 and mutex_n to which the subsequent numbers are added are allocated to the other IPs 24.

It is assumed that the task CPU 22 and each IP 24 which locked these mutexes transition to a special priority in the ready queue 52, and all tasks are in a run state in the special priority. For example, when the system is activated, the task CPU 22, each IP and a program which operates on the task CPU 22 require initialization and initial setting, and further require a test. By implementing them at the same time, the activation time can be shortened.

Regarding these mutexes, locking by a power control IP is also permitted. The locking of the mutexes by the power control IP is implemented in a situation where the entire system transitions to a power-saving state. When the state transitions to a power-saving state, the power control IP attempts to lock all mutexes. When the task CPU 22 and the IPs 24 unlock their respective mutexes, all mutexes are locked by the power control IP. The task CPU 22 and each IP 24 transitions to a dormant state, and thus, cannot lock the mutexes.

When a situation where there is no task in operation in the ready queue 52 is realized in the above manner, the kernel CPU 21 permits the power control IP to transition to a power-saving state.

For example, in the example of FIG. 5, a power-saving task managed by the kernel CPU 21 and having a low priority locks mutex_1 to mutex_N in advance. When it is determined that the transition to a power-saving state is needed, the kernel CPU 21 transmits a message to the tasks other than the power-saving task. When the message is received, the tasks attempt to lock mutex_1 to mutex_N dedicated to the tasks, respectively. When all tasks transition to a mutex lock wait state, the power-saving task obtains the right of execution, and causes the entire system to transition to a power-saving state.

As described above, the memory system 1 of the second embodiment can optimize power consumption by considering power as a resource and introducing appropriate execution control between the task CPU 22 and each IP 24 by the kernel CPU 21.

### Third Embodiment

Now, this specification explains a third embodiment. In a manner similar to that of the first embodiment, the third embodiment is assumed to be a memory system 1 realized as, for example, an SSD. The same structural elements as the first embodiment are denoted by the same reference numbers. Thus, explanation thereof is omitted.

The memory system 1 of the third embodiment is also an example of an application using the configuration explained in the first embodiment in which two CPUs, specifically, a kernel CPU 21 and a task CPU 22, are provided, and the task CPU 22 operates under the control of the kernel CPU 21. Specifically, the effective updating of the operation parameter of an operation device having a plurality of channels is realized.

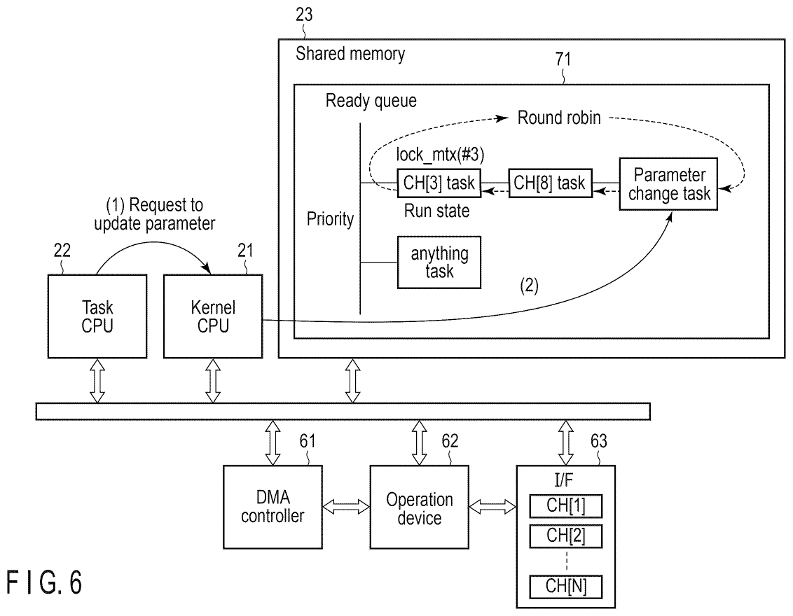

FIG. 6 is a diagram for explaining effective updating of the operation parameter of an operation device having a plurality of channels realized by the memory system 1 according to the third embodiment.

As shown in FIG. 6, here, it is assumed that an operation device 62 comprising a direct memory access (DMA) controller 61 is connected to a system bus, and this operation device 62 is operated by a plurality of tasks. To accept a plurality of processes, an interface 63 including a plurality of channels is mounted on the DMA controller 61. It is assumed that a plurality of operation methods are mounted on the operation device 62, and the operation method can be specified via the interface 63 by selecting a channel.

When a parameter related to a specific operation method is changed at an arbitrary time point, the control of the operation device 62 is extremely difficult. If the security process changes the parameter of the operation device 62, the procedure of stopping the request to the operation device 62 and confirming the stop of the operation device 62 is needed. Thus, the process has to be suspended for the reason different from an interruption.

To avoid this situation, in the third embodiment, each channel of the operation device 62 is dealt with as a task. The task CPU 22 notifies the kernel CPU 21 of the operation method to be changed and the parameter to be updated (FIG. 6 (1)). The kernel CPU 21 which received this notification generates a parameter change task managed by itself (FIG. 6 (2)).

The parameter change task attempts to lock mutex_algorithm #N associated with the operation method to be operated when the task transitions to a run state. If the parameter change task succeeded in the locking of the mutex, the parameter change task accesses the operation device 62 and updates the parameter of the target operation method. After updating the parameter, the parameter change task unlocks the mutex. To the contrary, when the mutex cannot be locked, the parameter change task transitions to a mutex lock wait state, is connected to the mutex wait queue managed by the kernel CPU 21 and is managed.

In this manner, in the third embodiment, each channel of the operation device 62 is dealt with as a task. A channel (channel task) which received a request for operation attempts to lock mutex_algorithm #N associated with the specified operation method. If the channel task succeeded in the locking of the mutex, the channel setting becomes effective, and an operation is started. After the operation is finished, the channel task unlocks the locked mutex.

In a case where the right of execution of a channel task and a parameter change task is switched in round-robin fashion (assuming that a dispatcher is called after the operation start setting), the mutex to be locked by a parameter change task may not be in a state which can be locked at the time point that the parameter change task has transitioned to a run state. At that time, the parameter change task transitions to a mutex lock wait state, and is removed from a ready queue 71 managed by the kernel CPU 21. The parameter change task locks the target mutex at the time point that the mutex is unlocked.

The memory system 1 realized as an SSD etc., in the third embodiment can also replace the relationship between a channel task and a parameter change task as described above with, for example, the relationship between a channel task which is responsible for the access to a specific namespace in accordance with a request from the host 2 and the task CPU 22 which operates a parameter related to a specific namespace in accordance with a request from the host 2.

In this case, the memory system 1 of the third embodiment can realize access and parameter updating via a mutex corresponding to a namespace. This mechanism can exclude unprepared suspension or late for data access as well as a security process.

As described above, the memory system 1 of the third embodiment can realize the effective updating of the operation parameter of the operation device having a plurality of channels.

While certain embodiments have been described, these embodiments have been presented by way of example only, and are not intended to limit the scope of the inventions. Indeed, the novel devices and methods described herein may be embodied in a variety of other forms; furthermore, various omissions, substitutions and changes in the form of the embodiments described herein may be made without departing from the spirit of the inventions. The accompanying claims and their equivalents are intended to cover such forms or modification as would fall within the scope and spirit of the inventions.

What is claimed is:

1. A memory system comprising:
a nonvolatile memory; and
a controller comprising a security block configured to provide a security function related to the nonvolatile memory, wherein
the security block comprises:
a first CPU configured to
perform communication with an external module which requests the security function,
accept an interruption generated in the security block, and
perform task management in the security block such that a security process corresponding to the request is performed without suspension considering the security process as one task; and
a second CPU configured to perform the security process under control of the first CPU.

2. The memory system of claim 1, wherein
the first CPU is further configured to
monitor whether the second CPU is in a wait state or an execution state,
manage one or more tasks which are respectively security processes corresponding to requests from the external module in order of high to low priority, and
cause the second CPU to execute a task having a highest priority among the one or more tasks when the second CPU is in the wait state.

3. The memory system of claim 1, wherein
the security block comprises a shared memory, and
the first CPU is further configured to
store data used to perform the security process in the shared memory, and
instruct the second CPU to perform the security process.

4. The memory system of claim 3, wherein
the first CPU is further configured to
prepare, in the shared memory, a first queue in which a request from the external module is stored, a second queue in which information indicating the second CPU is stored when the second CPU is in a wait state, and a third queue in which the information indicating the second CPU is stored when the second CPU is in an execution state,
when the request from the external module is stored in the first queue, and when the information indicating the second CPU is stored in the second queue, instruct the second CPU to perform the security process corresponding to the request from the external module stored in the first queue, remove the information indicating the second CPU from the second queue and store the information in the third queue, and
when the second CPU terminates the security process, remove the information indicating the second CPU from the third queue and store the information in the second queue.

5. The memory system of claim 1, wherein a mail box mechanism for communication is provided between the external module and the first CPU.

6. The memory system of claim 1, wherein
the controller comprises a processor, and
the processor is configured to request the security block for the security function as the external module.

7. The memory system of claim 1, wherein
the nonvolatile memory is a NAND flash memory.

8. The memory system of claim 1, wherein
the controller executes communication with a host compliant with a PCI Express™ (PCIe™).

9. A memory system comprising:
a nonvolatile memory; and
a controller configured to control the nonvolatile memory, wherein
the controller comprises a first CPU, a second CPU and one or more processing circuits, and
the first CPU is configured to perform task management in the controller such that power supplied to the controller is exclusively used by the second CPU and one of the one or more processing circuits, considering the second CPU and each of the one or more processing circuits as one task.

10. The memory system of claim 9, wherein
the second CPU and the one or more processing circuits are configured to exclusively obtain an operation right by an exclusive control mechanism provided in the controller, and
the first CPU is further configured to
monitor whether or not each of the second CPU and the one or more processing circuits is in a state where the operation right has been obtained; and
perform task management in the controller so as to operate only the second CPU or one of the one or more processing circuits in a state where the operation right has been obtained.

11. The memory system of claim 9, wherein
the nonvolatile memory is a NAND flash memory.

12. The memory system of claim 9, wherein
the controller executes communication with a host compliant with a PCI Express™ (PCIe™).

13. A memory system comprising:
a nonvolatile memory; and
a controller configured to control the nonvolatile memory, wherein
the controller comprises a CPU, and an operation device having an interface including a plurality of channels with which respective operation processes are associated, and
the CPU is configured to, when considering each of the operation processes associated with the channels as one task, and when updating of a parameter related to an operation process associated with one of the channels occurs, perform task management in the controller such that the operation processes and an updating process of the parameter are exclusively performed, considering the updating process of the parameter as one task equivalent to the operation processes.

14. The memory system of claim 13, wherein
the operation processes and the updating process of the parameter exclusively obtain an execution right by an exclusive control mechanism provided in the controller, and
the CPU is further configured to
monitor whether or not each of the operation processes and the updating process of the parameter is in a state where the execution right has been obtained; and
perform task management in the controller such that the updating process of the parameter is performed in a situation where all of the operation processes are in an execution wait state.

15. The memory system of claim 13, wherein
the nonvolatile memory is a NAND flash memory.

16. The memory system of claim 13, wherein
the controller executes communication with a host compliant with a PCI Express™ (PCIe™).
